(19) United States
(12) Patent Application Publication
(10) Pub. No.: US 2012/0160180 A1
(43) Pub. Date: Jun. 28, 2012

(54) EDIBLE PET CHEW

(75) Inventors: Stewart Townsend, Franklin, TN (US); Jason Michael Friedland, Franklin, TN (US); Peter Slusarczyk, Nolensville, TN (US)

(73) Assignee: Mars Incorporated, McLean, VA (US)

(21) Appl. No.: 13/415,469

(22) Filed: Mar. 8, 2012

Related U.S. Application Data
(63) Continuation of application No. 11/937,291, filed on Nov. 8, 2007.

(51) Int. Cl. A01K 29/00; A01K 15/02

(52) U.S. Cl. 119/709

(57) ABSTRACT

An edible pet chew having a non-branching body configured to at least partially enclose an open space between portions of the body, and is preferably in the form of a ring with a central opening. The width or thickness of the chew is sized to fit within the mouth of pet of pre-determined size for chewing action, but the overall dimension of the chew is such that the chew cannot be swallowed whole by the pet. One or more lines of weakness may also be formed in the body of the pet chew to serve as pre-determined fracture lines along which the pet chew will break into smaller pieces. The pet chew may be formed of segments that are sized to provide a recommended single portion for the pet.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention is directed to the field of pet products, and is more specifically directed to an edible pet chew having a unique configuration that enables a pet owner to grasp the pet chew when in use, promotes prolonged chewing or gnawing for improved dental hygiene, and reduces the risk of choking and intestinal blockage caused by swallowing the product whole and unchewed.

2. Description of Related Art

A variety of different pet chews have been developed, particularly for dogs and puppies, to assist in promoting healthy teeth and gums. Some of these pet chews are made of rubber, plastic, or some other non-edible material wherein the chew promotes dental health simply by virtue of the pressure and action of the teeth and gums against or on the product. Edible pet chews have also been developed wherein the chew is of a sufficient hardness to provide the physical benefits of exercising the teeth and gums by mechanical abrasion, but also may be more flavorful and appealing to a dog because it is edible in nature. The edible chews can also include ingredients that further assist in dental hygiene or provide other benefits to the pet, such as tartar control agents, breath freshening agents, vitamins, supplements, and the like.

Edible pet chew products currently available in the marketplace can be loosely grouped into two categories. One type is relatively hard and friable, which crumbles or breaks down relatively quickly, but has relatively short lasting times in consumption. The second group is comprised of highly dense or compacted products with more elastic or rubbery properties that are more difficult to chew, possibly harder to digest, and have more extended lasting times in consumption. While this second group of products, in particular, can be very effective in teeth cleaning, it also poses some risk of choking or blockage of the digestive system if the pet swallows the product whole or in large pieces without chewing. For this reason, it is important to monitor the pet carefully to assure that they are chewing the product into smaller pieces before swallowing, thereby enhancing the dental benefits and reducing the risk of choking or intestinal blockage. This is particularly true for puppies that tend to swallow rather than chew due to their rambunctious nature.

Edible pet chews have been provided in a variety of configurations including elongated dog bone or brush shapes, as well as branched Y, star and jack shapes. While the elongated shapes have utility, they do not necessarily facilitate prolonged chewing or gnawing because they are somewhat more difficult to grasp or hold by the pet. The branched shaped products do provide means for better holding the chew, but may present an increased risk of choking or intestinal blockage due to the ease of breaking off a large chunk of material off at the branch point of the chew which can then be swallowed whole. None of these shapes are particularly amenable to a pet owner grasping the chew, such as to take it away from the pet if it is consuming the chew too quickly, without risk of accidental biting.

Considering the foregoing, there remains a need for a product that is completely edible, long lasting and safe, that is designed to effectively clean teeth without risk of health damage such as choking or intestinal obstruction. Furthermore, particularly in relation to puppies, a need remains for a pet chew that will enable the pet owner or other person to assist in controlling the puppy's consumption of the pet treat to make sure that the puppy adequately chews the product rather than simply swallowing larger pieces so as to enhance the dental effectiveness of the product while reducing the risk of injury.

### BRIEF SUMMARY OF THE INVENTION

The present invention is directed to an edible pet chew having a non-branching body configured to at least partially enclose an open space between portions of the body, wherein the width or thickness of the chew is sized to fit within the mouth of pet of pre-determined size for chewing action, but the overall dimension of the chew is such that the chew cannot be swallowed whole by the pet. The body preferably has a minimum outer diameter that is at least twice the size of the width of the pet's jaw. Thus, the pet must repeatedly bite down on the pet chew to cause portions of the chew to break away into smaller pieces for swallowing. One or more lines of weakness may also be formed in the body of the pet chew to serve as pre-determined fracture lines along which the pet chew will break into smaller pieces.

The open space formed between portions of the body enables the pet to securely hold a portion of the pet chew while it gnaws or chews on other portions. In addition, this configuration enables a pet owner to grasp one portion of the chew while the pet is gnawing on another portion with less risk of being accidentally bitten. The pet owner can therefore more easily control the amount and speed with which the pet consumes portions of the pet chew by removing the chew when deemed necessary. The pet owner can also easily grasp and hold a portion of the pet chew to play “tug of war” or otherwise manipulate the pet chew for increased interaction and play with the pet. This is particularly advantageous for use with puppies in order to stimulate them to chew or gnaw on the pet chew. Since the pet chew is formed of a non-branching body, the overall size of breakaway pieces of the pet chew can be more easily controlled and present less risk of choking or intestinal blockage to the pet. The pet chew of the present invention is therefore designed to remove plaque and tartar through mechanical abrasion while providing safe occupation and enjoyment for the pet.

For purposes of this invention, “non-branching body” means that the body shape may be drawn as a continuous single line without any branches. This line is curved or bent to at least partially enclose an open space between portions of the body. The body may, for example, be configured as a partially enclosed “C”, “U” or “V” shaped body. For purposes of this invention, “partially enclosed” means that the length of that portion of the body enclosing the opening is greater than the distance between any gap in the enclosure. For example, in the case of a “U” shaped body, the length of the body is determined by measuring the full length of the line that makes up the “U” and the length of the gap is the distance between the upper free ends of the “U.” In a preferred embodiment, the length of the body is at least twice the length of the gap, preferably at least three times the length of the gap, and most preferably over three times the length of the gap. Most preferably, the body is a fully enclosed ring, which for purposes of this invention, means any shape defining a central opening that is fully enclosed, including, without limitation, circular, oval, triangular, square, and rectangular shapes.

The body may be contoured to have surface variations that increase the surface area of the body for contact with the pet's tongue and teeth. This will also help improve maneuverability in the mouth. These surface variations may include indentations such as channels or grooves or may include protuberances such as bumps, ribs, ridges, bulbous knots, knuckles, teeth, bristles, or nubs. In a preferred embodiment, protuberances may be provided at spaced intervals along the top and/or bottom surface of the pet chew so as to form “legs” on which the pet chew can stand. By limiting the amount of surface area of the pet chew in contact with the floor, this will assist in keeping the floor clean.

In a preferred embodiment, the pet chew comprises a segmented body wherein lines of weakness extend across the width of the body at spaced intervals along the length of the body in order to form a plurality of segments. Preferably, the body has at least three segments and most preferably has four to eight segments. Each segment is preferably sized to approximate a recommended single portion for the pet of a pre-determined size. This enables the pet owner to better monitor the amount of chew being consumed by the pet and the pet owner can take the chew away once the recommended single portion has been chewed during any given period. The segments may be contoured to form various shapes, such as the shape of a dog bone.

In a preferred embodiment, the segments are each contoured in the shape of Greenies® pet chews having an iconic bone knuckle on one end, a central shaft and brush shaped head on the other end. The position of the brush shaped head can be alternated such that it faces upward from the top surface of one segment and faces downward from the bottom surface of an adjacent segment. In this fashion, the brush shaped heads also serve as “legs” upon which the pet chew can stand when lying on a floor or other surface.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a pet chew in accordance with a preferred embodiment of the present invention;

FIG. 2 is a side elevational view of the pet chew of FIG. 1;

FIG. 3 is a top plan view of the pet chew of FIG. 1;

FIG. 4 is a perspective view of a pet chew in accordance with an alternative preferred embodiment of the present invention;

FIG. 5 is a side elevational view of the pet chew of FIG. 4;

FIG. 6 is a top plan view of the pet chew of FIG. 4;

FIG. 7 is a perspective view of the pet chew of FIG. 1 being grasped by a person; and

FIG. 8 is a perspective view of the pet chew of FIG. 1 being grasped by a person wherein a segment of the pet chew has been removed by a dog.

### DETAILED DESCRIPTION OF PREFERRED EMBODIMENT

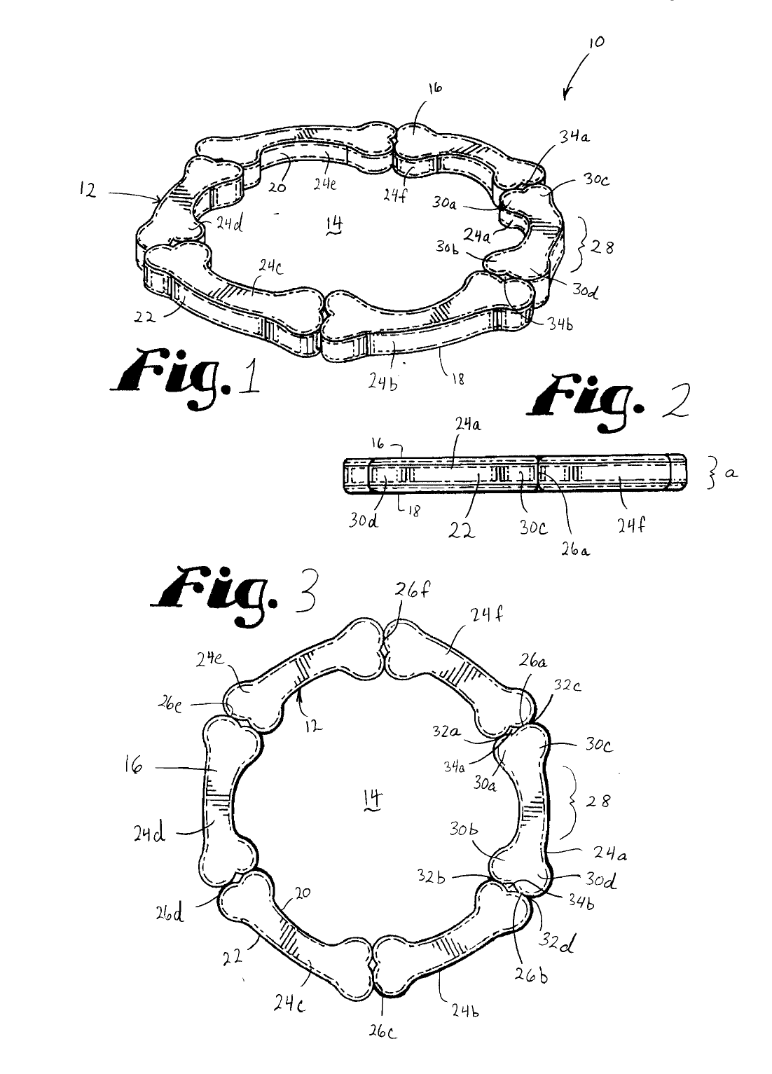

With reference to FIGS. 1-3, a segmented pet chew in accordance with a preferred embodiment of the present invention is denoted by the numeral 10. Pet chew 10 is in the form of a segmented circular ring 12 having a central opening 14. Top and bottom surfaces 16, 18 of ring 12 are generally planar and parallel one another such that the thickness a of chew 10 is generally uniform. Inner and outer sides 20, 22 are contoured to form six bone shaped segments 24a, 24b, 24c, 24d, 24e, 24f extending end-to-end in series along the circumferential length of ring 12. Lines of weakness 26a, 26b, 26c, 26d, 26e, 26f extending from inner side 20 to outer side 22 at the juncture of adjacent segments 24 enables the segments to be more easily broken away from the remainder of ring 12.

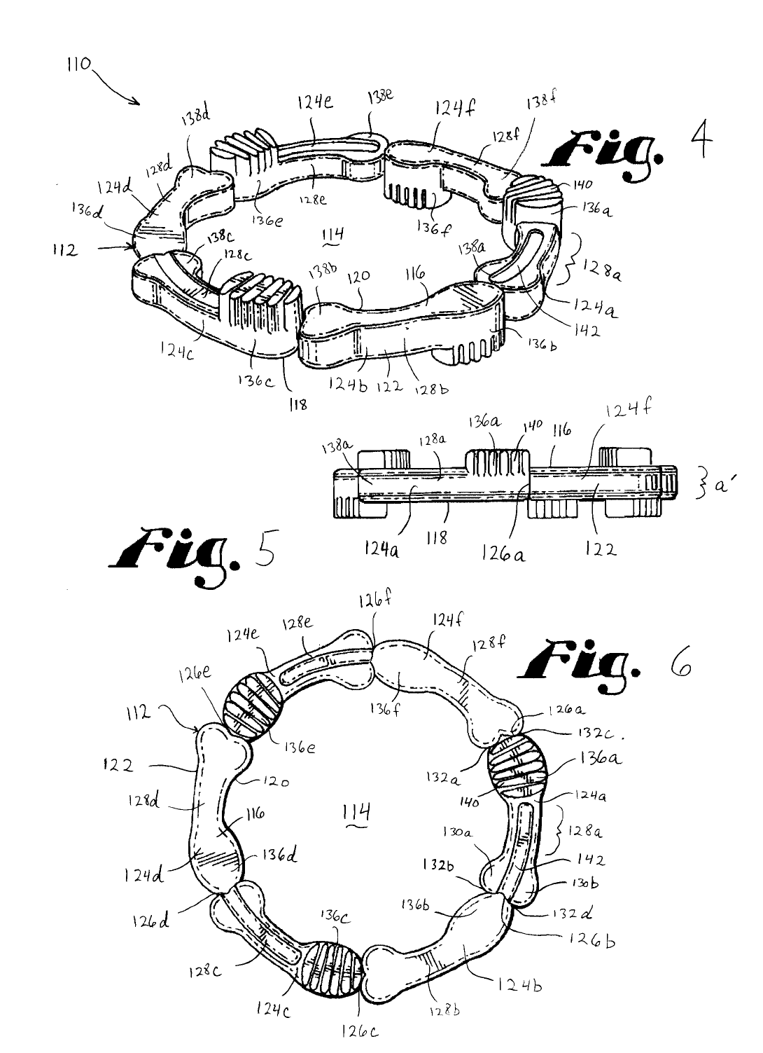

In this preferred embodiment, the shape, configuration, and size of each segment 24a, 24b, 24c, 24d, 24e, 24f is uniform. For ease of reference, segment 24a will therefore be described more fully with the understanding that the description equally applies to remaining segments 24b, 24c, 24d, 24e, 24f. Inner and outer sides 20, 22 extend generally parallel one another along a central portion of segment 24a to form an elongated shaft 28. Inner and outer sides 20, 22 extend away from the generally parallel sides of shaft 28 to form two rounded protuberances 30a, 30b, 30c, 30d respectively, at each end of segment 24a. Rounded protuberances 30 are configured to mimic the appearance of an iconic bone knuckle. As best seen in FIG. 3, inner and outer sides 20, 22 extend around each end of segment 24a toward the centerline of the chew to thereby form v-shaped indentations 32a, 32b, 32c, 32d respectively, at the juncture of segment 24a and adjacent segments 24b, 24f. In addition, a diamond shaped open space 34a, 34b is formed adjacent the centerline of the ring at the juncture of segment 24a and adjacent segments 24b, 24f to further mimic the appearance of an iconic bone knuckle. V-shaped indentations 32 and diamond shaped open spaces 34 further promote breakage of segment 24a away from the remainder of ring 12 at the lines of weakness 26a, 26b.

Looking to FIGS. 4-6, a segmented pet chew in accordance with an alternative preferred embodiment of the present invention is denoted by the numeral 110. Pet chew 110 is in the form of a segmented ring 112 having a central opening 114. In this embodiment, top and bottom surfaces 116, 118 and inner and outer sides 120, 122 are contoured to form six segments 124a, 124b, 124c, 124d, 124e, 124f having a shape similar to commercially available pet chews sold under the brand name Greenies®. The segments 124 are positioned end-to-end in series along the circumferential length of ring 112. Lines of weakness 126a, 126b, 126c, 126d, 126e, 126f extending from inner side 120 to outer side 122 at the juncture of adjacent segments 124 enables the segments to be more easily broken away from the remainder of ring 112.

Segments 124 each comprise a brush-shaped head 136a, 136b, 136c, 136d, 136e, 136f connected by a central elongated shaft 128a, 128b, 128c, 128d, 128e, 128f to a bone-shaped tail 138a, 138b, 138c, 138d, 138e, 138f. The thickness of the shaft 128 and bone-shaped tail 138 of each segment 124 is shown in FIG. 5 as a′. Segments 124 are in alternating positions within the ring such that the brush-shaped head 136 extends upwardly from the top surface of segments 124a, 124c, 124e, and extends downwardly from the bottom surface of segments 124b, 124d, 124f. Given that the segments 124 are substantially uniform in shape, configuration, and size, segment 124a will be described more fully with the understanding that the description applies to remaining segments 124b, 124c, 124d, 124e, 124f, albeit the brush head 136 and groove 142 (described hereinafter) extends from bottom surface 118 as opposed to top surface 116 in segments 124b, 124d, 124f.

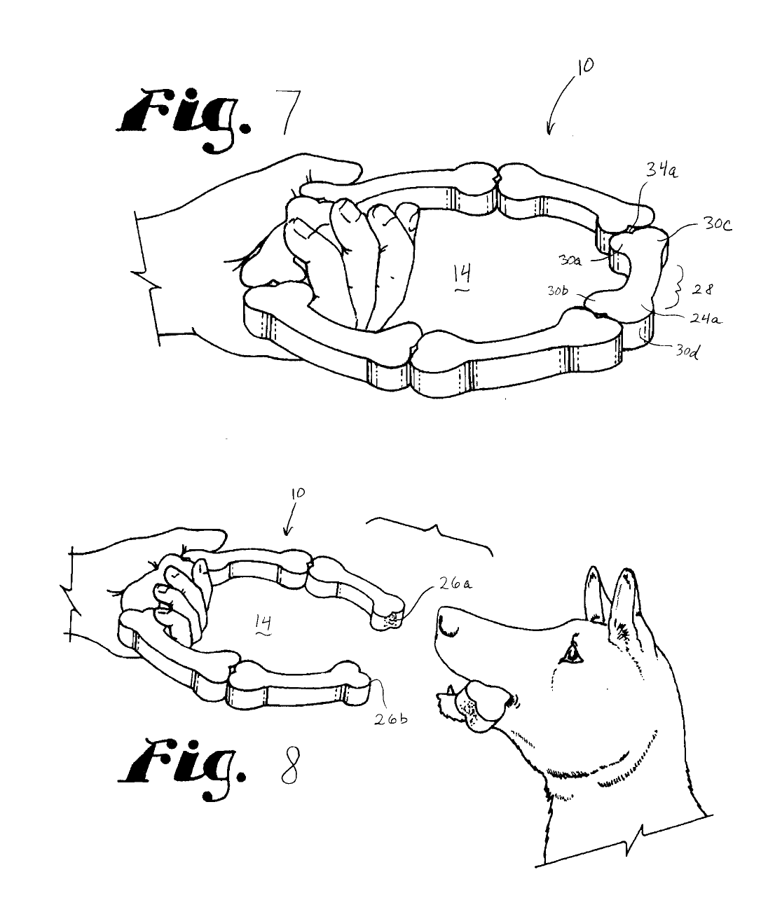

Inner and outer sides 120, 122 extend generally parallel one another along a central portion of segment 124a to form elongated shaft 128a. Inner and outer sides 120, 122 gently slope away from the generally parallel sides of shaft 128a to form rounded brush-shaped head 136a on one end of segment 124a and gently slope away from the generally parallel sides of shaft 128a to form two rounded protuberances 130a, 130b at a tail end of segment 124a. These rounded protuberances 130a, 130b are configured to mimic the appearance of an iconic bone knuckle. As best seen in FIG. 6, inner and outer sides 120, 122 extend around each end of segment 124a toward the centerline of chew 112 to thereby form v-shaped indentations 132a, 132b, 132c, 132d respectively, at the juncture of segment 124a and adjacent segments 124b, 124f. V-shaped indentations 132 further promote breakage of segment 124a away from the remainder of ring 112 at the lines of weakness 126a, 126b.

A plurality of bristle sections 140 extends upwardly from top surface 116 of the brush-shaped head 136a to approximate the “bristles” of a brush. Bristle sections 140 are approximately parallel one another and preferably have angled spaces between them (not shown), so that when a dog bites brush-shaped head 136a, the natural shape of a dog's tooth is accommodated by being able to fit into these spaces, increasing the surface area of chew 112 in contact with the tooth. This contact of a dog's tooth against the surface of chew 112, in addition to the contact arising from the penetration of a dog's tooth into the body of chew 112, results in a cleaning action on the dog's teeth. The spaces between the bristle sections 140 create predetermined fracture lines so that the dog chew breaks along those lines when the dog chews on it. This increases the solubility of the pieces in the dog's digestive tract by increasing the surface area.

At least one groove 142 extends from tail 138a along top surface 116 of shaft 128a so that fracture lines preferentially form in that area when a dog bites on chew 112. This increases the fracturability of the chew in that area and guides a dog's teeth to that area when the dog is in the process of biting the chew. Groove 142 is the thinnest part of shaft 128a, and therefore the chew is more apt to break at that point. Although not shown in the Figures, a groove may also be presented along the bottom surface 118 of shaft 128a.

Looking to FIG. 7, the ring shape of pet chew 10 enables a pet owner to firmly grasp or hold one part of the chew while the dog is chewing or gnawing on another remote part of the chew. Central opening 14 provides sufficient space between the dog's mouth and the owner's hand so as to prevent accidental biting. This configuration also enables the pet owner to play “tug of war” or otherwise manipulate the pet chew to enhance interaction with the dog and stimulate chewing or gnawing on the chew. In addition, given that the pet owner can grasp the chew in a location remote from the part of the chew that is being gnawed on by the dog, the pet owner can more effectively take the chew away from the dog when deemed necessary to control consumption of the chew.

As shown in FIG. 8, the overall dimension or size of pet chew 10 is such that a dog of pre-determined size cannot swallow the entirety of the pet chew whole. The minimum outer diameter of pet chew 10, 110 is preferably at least twice the length, most preferably at least three times the length, of the width between the upper first molar teeth of a pet of pre-determined size. For example, a pet chew made for consumption by extra-large dogs (>100 pounds) generally having a width between the upper first molar teeth ranging from 6.75 cm to 8.00 cm will have a minimum diameter ranging from 12 cm to 32 cm and preferably ranging from 20 cm to 24 cm. For large dogs (50-100 pounds) having a width between the upper first molar teeth ranging from 4.75 cm to 7.5 cm, the minimum outer diameter of the pet chew ranges from about 9.5 cm to 28 cm, preferably ranges from 14 cm to 22 cm. For medium dogs (25-50 pounds) having a width between the upper first molar teeth ranging from 4.5 cm to 7.5 cm, the outer diameter of the pet chew ranges from about 9 cm to 28 cm, preferably ranges from 13 cm to 22 cm. For small dogs (15-25 pounds) having a width between the upper first molar teeth ranging from 4.25 cm to 5.5 cm, the outer diameter of the pet chew ranges from about 8.5 cm to 20 cm, preferably ranges from 13 cm to 17 cm. For extra-small or petite dogs (<15 pounds) having a width between the upper first molar teeth ranging from 2.5 cm to 4.75 cm, the outer diameter of the pet chew ranges from about 5 cm to 19 cm, preferably ranges from 7.5 cm to 14.25 cm.

Since the ring body is generally linear and non-branching, the minimum width of chew 10, 110 as measured radially from inner side 20, 120 to outer side 22, 122 at any given point along the shaft 28, 128 of a segment 24, 124 is small enough for a dog to bite over the shaft putting a portion of the chew between his front fangs and back canine teeth. This enables the dog to rub his teeth against the inner and outer sides 20, 22, 120, 122 of the chew for better teeth cleaning, and also enables the dog to bite into the chew and break it down into smaller portions before swallowing.

Similarly, the thickness a, a′ of the chew is such that a dog can easily get its mouth around the chew for biting on the top and bottom surfaces 16, 18, 116, 118 of the chew. For extra-large dogs having a gape size (preferably measured between the upper and lower 3rd premolar teeth) ranging from 6.5 cm to 10 cm, thickness a, a′ of the pet chew preferably ranges from about 0.75 cm to 4 cm. For large dogs having a gape size ranging from 3.5 cm to 8.75 cm, thickness a, a′ preferably ranges from about 0.5 cm to 3.5 cm. For medium dogs having a gape size ranging from 1.5 cm to 5.5 cm, thickness a, a′ preferably ranges from about 0.25 cm to 3.0 cm. For small dogs having a gape size ranging from 0.7 cm to 5.5 cm, thickness a, a′ preferably ranges from about 0.25 cm to 2.5 cm. For extra-small or petite dogs having a gape size ranging from 0.2 cm to 2.75 cm, thickness a, a′ preferably ranges from about 0.1 cm to 2.0 cm.

Each segment 24, 124 of the pet chew 10, 110 is preferably dimensioned to comprise a single recommended portion size for the type or size of dog for which the pet treat is made. Veterinarians recommend that treats make up no more than 10% of your dogs caloric intake. The segments essentially serve as a measuring stick enabling the pet owner to better monitor the amount of pet chew being consumed by the dog during any given time period. For extra-large dogs (>100 pounds), the caloric content of each segment preferably ranges from about 50 kcal to 400 kcal. For large dogs (50-100 pounds) the caloric content of each segment preferably ranges from about 20 kcal to 250 kcal. For medium dogs (25-50 pounds) the caloric content of each segment preferably ranges from about 10 kcal to 150 kcal. For small dogs (15-25 pounds) the caloric content of each segment preferably ranges from about 5 kcal to 100 kcal. For extra-small or petite dogs (<15 pounds) the caloric content of each segment preferably ranges from about 3 kcal to 50 kcal.

Pet chew 10, 110 may be formed of any solid, edible material suitable for pet consumption and is preferably made of a material that provides high flexibility and elastic properties to improve chewing enjoyment and lasting time, but also breaks down or fractures under mechanical stress to avoid the release of large pieces that can be swallowed intact. While any materials now known and hereafter developed for use as an edible pet chew material are considered suitable for purposes of the present invention, in order to obtain the desired shape of the chew, the material is preferably made of a thermoplastic or other material that can be molded or extruded. Preferred compositions used to make the pet chew and methods for extruding the pet chew are described in U.S. patent application Ser. No. 11/060,943, the entire disclosure of which is incorporated herein by reference. The composition of the dog chew may be selected to enhance the effect of the lines of weakness and predetermined fracture lines. A composition that yields a softer, more elastic dog chew will also tend to assist the breakage along the predetermined fracture lines, rather than along crystal lines of the extruded product. Compositions formulated to enhance the ability of product to be sheared apart with a wedge action of a dog's teeth, as described in U.S. Provisional Patent Application No. 60/815,682 [Attorney Docket No. 02280.003950], the entire disclosure of which is also incorporated by reference, may be adapted for use in accordance with the present invention.

A particularly preferred method for designing and marketing the pet chew for dogs using biometric analysis, such as described in U.S. Provisional Patent Application No. 60/821,000 [Attorney Docket No. 02280.003960], may be utilized in accordance with this invention, the entire disclosure of which is incorporated by reference herein.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense. Of particular import, while the pet chew has been shown in the drawings as a segmented circular ring shaped pet chew, it is anticipated that the pet chew may be a variety of other shapes, including, without limitation, partially enclosed “C,” “U,” or “V” shaped chews, as well as fully enclosed rings that are oval, triangular, square, or rectangular in shape. In addition, the pet chew need not be segmented, and, if segmented, the segments can be of non-uniform size and shape. Furthermore, the pet treat may include any number of different surface variations, including, without limitation, bumps, ridges, ribs, channels, grooves, nubs, points, bristles, teeth, and combinations thereof.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An edible pet chew configured for consumption by a pet of pre-determined size, said pet chew comprising a non-branching body formed of an edible material and configured to define at least one open space that is at least partially enclosed by the body, wherein portions of the body are sized to fit within the mouth of a pet of pre-determined size and wherein the outer dimension of the chew is such that the chew cannot be swallowed whole by a pet of pre-determined size.

2. An edible pet chew according to claim 1, wherein said body has a partially enclosed configuration selected from the group consisting of a “C” shaped body, a “U” shaped body and a “V” shaped body.

3. An edible pet chew according to claim 1, wherein said body has the configuration of a fully enclosed ring.

4. An edible pet chew according to claim 3 wherein said configuration is selected from the group consisting of a circular ring shaped body, a triangular ring shaped body, a square ring shaped body, and a rectangular ring shaped body.

5. An edible pet chew according to claim 1, wherein the pet chew has a minimum outer diameter that is at least twice the width between the upper first molar teeth of a pet of pre-determined size.

6. An edible pet chew according to claim 1, wherein said body comprises at least one line of weakness.

7. An edible pet chew according to claim 1, wherein said body comprises surface variations that increase the surface area of the body for contact with a pet's teeth.

8. An edible pet chew according to claim 7, wherein said surface variations are selected from the group consisting of indentations, protuberances, and combinations thereof.

9. An edible pet chew according to claim 1, wherein said body comprises a plurality of segments separated by lines of weakness.

10. An edible pet chew according to claim 1, wherein said segments are sized to serve as a recommended single portion for a pet of pre-determined size.

11. An edible pet chew configured for consumption by a pet of pre-determined size, said pet chew comprising a ring defining a central opening and formed of an edible material, said ring having an outer circumference of sufficient size such that the chew cannot be swallowed whole by a pet of pre-determined size and comprising a plurality of segments separated by lines of weakness.

12. An edible pet chew according to claim 11, wherein said segments are sized to serve as a recommended single portion for a pet of pre-determined size.

13. An edible pet chew according to claim 11, wherein said ring comprises a top surface, a bottom surface, an inner side and an outer side, and wherein said lines of weakness extend across said ring from said inner side to said outer side at equidistant locations along the circumferential length of the ring.

14. An edible pet chew according to claim 11, wherein at least one of said top surface, said bottom surface, said inner side, or said outer side comprises surface variations are selected from the group consisting of indentations, protuberances, and combinations thereof.

15. An edible pet chew according to claim 14, wherein protuberances extend from said inner side and said outer side of the ring in at least one segment.

16. An edible pet chew according to claim 15, wherein said protuberances extend adjacent at least one end of said at least one segment.

17. An edible pet chew according to claim 16, wherein said protuberances are shaped to mimic the shape of a bone knuckle.

18. An edible pet chew according to claim 16, wherein said protuberances are shaped to mimic the shape of a brush head.

19. An edible pet chew according to claim 14, wherein at least one of said top surface or said bottom surface comprises a protuberance.

20. An edible pet chew according to claim 19, wherein a plurality of protuberances extend outwardly from at least one of said top surface or said bottom surface at equidistant locations along the circumferential length of the ring.

21. An edible pet chew according to claim 19, wherein said protuberance is shaped to mimic the shape of a brush bristles.

22. An edible pet chew configured for consumption by a pet of pre-determined size, said pet chew comprising:
a ring-shaped body having a central opening and molded from an edible material, said ring-shaped body comprising a top surface, a bottom surface, an inner side and an outer side;
at least three lines of weakness extending from said inner side to said outer side at equidistant locations along a circumferential length of said body to define at least three segments;
the inner side and outer side of the body being contoured in each segment to provide surface variations that increase available surface area for contact with a pet's teeth; and
the top surface and bottom surface of the body being contoured in each segment to provide surface variations that increase available surface area for contact with a pet's teeth.
